(19) United States
(12) Patent Application Publication
(10) Pub. No.: US 2016/0004411 A1
(43) Pub. Date: Jan. 7, 2016

(54) Run-Time Adaptive Non-Uniform Mapping of Gesture User Interface Events

(71) Applicant: QUALCOMM Incorporated, San Diego, CA (US)

(72) Inventors: Fitzgerald John Archibald, Toronto (CA); Francis Bernard MacDougall, Milton (CA)

(21) Appl. No.: 14/323,833

(22) Filed: Jul. 3, 2014

(51) Int. Cl. G06F 3/0481; G06F 3/038

(52) U.S. Cl. CPC G06F 3/04812; G06F 3/038; G06F 2203/04803; G06F 2203/04801

(57) ABSTRACT

Disclosed is a method and apparatus for run-time adaptive non-uniform mapping of user interface events. In one embodiment, the operations implemented may include: categorizing a display area into a plurality of regions of either a first type or a second type; assigning a gravity value to each of the one or more regions of the second type; determining whether a cursor is within a first region of the first type and is being moved toward a second region of the second type that adjoins the first region; and in response to determining that the cursor is within the first region of the first type and is being moved toward the second region of the second type, the second region having a first gravity value, applying an acceleration factor based at least in part on the first gravity value to a cursor movement.

### FIELD

The present disclosure relates generally to cursor control in Graphical User Interfaces (GUIs). In particular, the present disclosure relates to methods for adaptive non-uniform mapping of gesture user interface events.

### BACKGROUNDS

A cursor (also called a pointer, or other suitable terms of art) is an indicator used to show the position on a Graphical User Interface (GUI) that will respond to user inputs. User inputs may include text selection, text entry, single click, double click, click-and-drag, etc. Different methods for moving a cursor on a GUI are known. For example, a user may use a mouse, a touch pad, a trackball, or any of a number of other similar devices to move the cursor and/or perform other operations on a GUI. Devices also exist that enable natural GUIs with which a user may interact with hand and/or arm gestures.

A process called mapping is used to translate a physical movement—be it a movement of a mouse, a finger movement on a touch pad, or a hand and/or arm movement, etc.—into a movement of a cursor on a GUI. Linear mapping is a simple form of mapping. With linear mapping, the speed or distance of a physical movement is translated into the speed or distance of a cursor movement with a constant ratio. Linear mapping may lead to cumbersome operations when, for example, a user desires to move a cursor over a long distance or at a very fast speed.

A known improvement over linear mapping is to increase the ratio between the speed of the cursor movement and the speed of the physical movement as the speed of the physical movement increases. With this improvement, a user may move a cursor over a long distance or at a very fast speed with a physical movement that is faster than usual—but not as fast as would be required with linear mapping. This improvement, however, does not take into account the operable elements on the GUI, and is not optimized for natural GUIs which a user operates with hand and/or arm movement.

### SUMMARY

An embodiment disclosed herein may include a method for run-time adaptive non-uniform mapping of user interface events comprising: categorizing a display area into a plurality of regions of either a first type or a second type, regions of the first type having no operable user interface object, and regions of the second type having at least one operable user interface object each; assigning a gravity value to each of the one or more regions of the second type; determining whether a cursor is within a first region of the first type and is being moved toward a second region of the second type that adjoins the first region; and in response to determining that the cursor is within the first region of the first type and is being moved toward the second region of the second type, the second region having a first gravity value, applying an acceleration factor based at least in part on the first gravity value to a cursor movement.

Another embodiment disclosed herein may include an apparatus adapted for a method for run-time adaptive non-uniform mapping of user interface events comprising: a memory; and a processor to: categorize a display area into a plurality of regions of either a first type or a second type, regions of the first type having no operable user interface object, and regions of the second type having at least one operable user interface object each, assign a gravity value to each of the one or more regions of the second type, determine whether a cursor is within a first region of the first type and is being moved toward a second region of the second type that adjoins the first region, and in response to determining that the cursor is within the first region of the first type and is being moved toward the second region of the second type, the second region having a first gravity value, apply an acceleration factor based at least in part on the first gravity value to a cursor movement.

A further embodiment disclosed herein may include an apparatus adapted for a method for run-time adaptive non-uniform mapping of user interface events comprising: means for categorizing a display area into a plurality of regions of either a first type or a second type, regions of the first type having no operable user interface object, and regions of the second type having at least one operable user interface object each; means for assigning a gravity value to each of the one or more regions of the second type; means for determining whether a cursor is within a first region of the first type and is being moved toward a second region of the second type that adjoins the first region; and means for in response to determining that the cursor is within the first region of the first type and is being moved toward the second region of the second type, the second region having a first gravity value, applying an acceleration factor based at least in part on the first gravity value to a cursor movement.

An additional embodiment disclosed herein may include a non-transitory computer-readable medium including code that, when executed by a processor, causes the processor to: categorize a display area into a plurality of regions of either a first type or a second type, regions of the first type having no operable user interface object, and regions of the second type having at least one operable user interface object each, assign gravity value to each of the one or more regions of the second type, determine whether a cursor is within a first region of the first type and is being moved toward a second region of the second type that adjoins the first region, and in response to determining that the cursor is within the first region of the first type and is being moved toward the second region of the second type, the second region having a first gravity value, apply an acceleration factor based at least in part on the first gravity value to a cursor movement.

### BRIEF DESCRIPTION OF THE DRAWINGS

FIG. 1 illustrates an embodiment of a computing device where embodiments of the disclosure may be practiced.

FIG. 2 is a flowchart illustrating an exemplary method for run-time adaptive non-uniform mapping of user interface events.

FIG. 3 illustrates an exemplary display area where methods for run-time adaptive non-uniform mapping of user interface events may be utilized.

### DETAILED DESCRIPTION

The word “exemplary” or “example” is used herein to mean “serving as an example, instance, or illustration.” Any aspect or embodiment described herein as “exemplary” or as an “example” is not necessarily to be construed as preferred or advantageous over other aspects or embodiments.

As used herein, the term “computing system or device” refers to any form of programmable computer device including but not limited to laptop and desktop computers, tablets, smartphones, televisions, home appliances, cellular telephones, personal television devices, personal data assistants (PDA's), palm-top computers, wireless electronic mail receivers, multimedia Internet enabled cellular telephones, Global Positioning System (GPS) receivers, wireless gaming controllers, receivers within vehicles (e.g., automobiles), interactive game devices, notebooks, smartbooks, netbooks, mobile television devices, or any data processing apparatus.

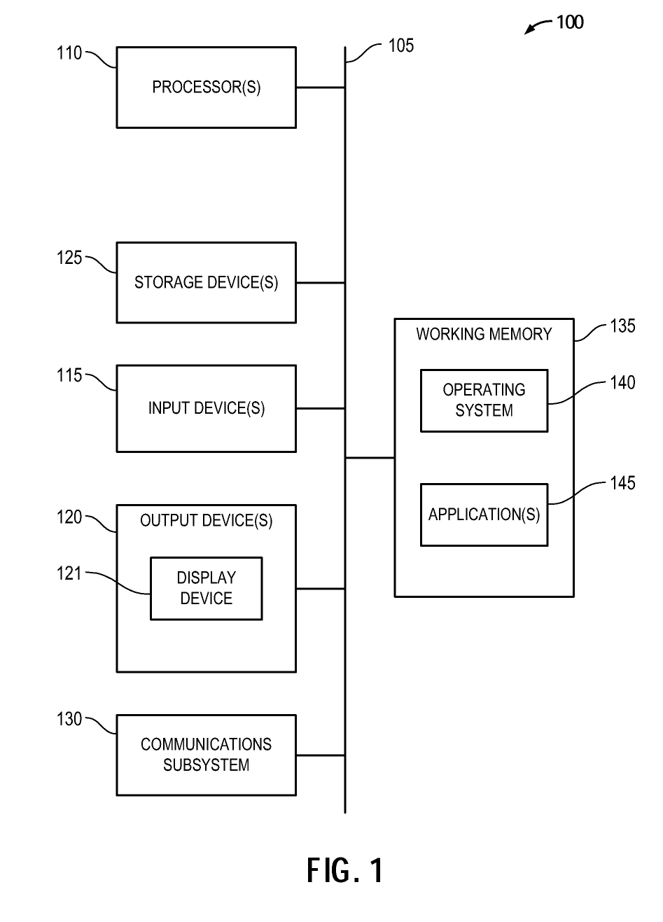

An example computing device 100 adapted for methods for run-time adaptive non-uniform mapping of user interface events is illustrated in FIG. 1. The computing device 100 is shown comprising hardware elements that can be electrically coupled via a bus 105 (or may otherwise be in communication, as appropriate). The hardware elements may include one or more processors 110, including without limitation one or more general-purpose processors and/or one or more special-purpose processors (such as digital signal processing chips, graphics acceleration processors, and/or the like); one or more input devices 115, which can include without limitation one or more sensors, a mouse, a keyboard, keypad, touch-screen, gesture input device, microphone and/or the like; and one or more output devices 120, which can include without limitation a display device 121, a speaker, a printer, and/or the like.

The computing device 100 may further include (and/or be in communication with) one or more non-transitory storage devices 125, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including without limitation, various file systems, database structures, and/or the like.

The computing device may also include a communication subsystem 130, which can include without limitation a modem, a network card (wireless or wired), an infrared communication device, a wireless communication device and/or chipset (such as a Bluetooth device, an 802.11 device, a Wi-Fi device, a WiMax device, cellular communication devices, etc.), and/or the like. The communications subsystem 130 may permit data to be exchanged with a network, other computing devices, and/or any other devices described herein. In one embodiment, the computing device 100 may further comprise a working memory 135, which can include a RAM or ROM device, as described above. It should be appreciated that computing device 100 may be a mobile device or a non-mobile device, and may have wireless and/or wired connections.

The computing device 100 may also comprise software elements, shown as being currently located within the working memory 135, including an operating system 140, device drivers, executable libraries, and/or other code, such as one or more application programs 145, which may comprise or may be designed to implement methods, and/or configure systems, provided by embodiments, as will be described herein. Merely by way of example, one or more procedures described with respect to the method(s) discussed below might be implemented as code and/or instructions executable by computing device 100 (and/or a processor 110 within computing device 100); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 125 described above. In some cases, the storage medium might be incorporated within a computing device, such as the device 100. In other embodiments, the storage medium might be separate from a computing device (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the computing device 100 and/or might take the form of source and/or installable code, which, upon compilation and/or installation on the computing device 100 (e.g., using any of a variety of generally available compilers, installation programs, compression/decompression utilities, etc.), then takes the form of executable code.

Embodiments of the present disclosure may relate to methods for run-time adaptive non-uniform mapping adapted for natural GUIs. According to embodiments of the disclosure, cursor movement may be accelerated when the cursor is within a region of the GUI where no operable objects are present and is being moved toward a region of the GUI where operable objects are present. Examples of operable objects include clickable links, icons, user interface (UI) buttons, sliders, selectable texts, etc.

Computing device 100 may comprise a memory 135 and a processor 110 to: categorize a display area into a plurality of regions of either a first type or a second type, one or more regions of the first type having no operable user interface object, and one or more regions of the second type having at least one operable user interface object each, assign a gravity value to each of the one or more regions of the second type, determine whether a cursor is within a first region of the first type and is being moved toward a second region of the second type that adjoins the first region, and in response to determining that the cursor is within the first region of the first type and is being moved toward the second region of the second type, the second region having a first gravity value, apply an acceleration factor based at least in part on the first gravity value to a cursor movement.

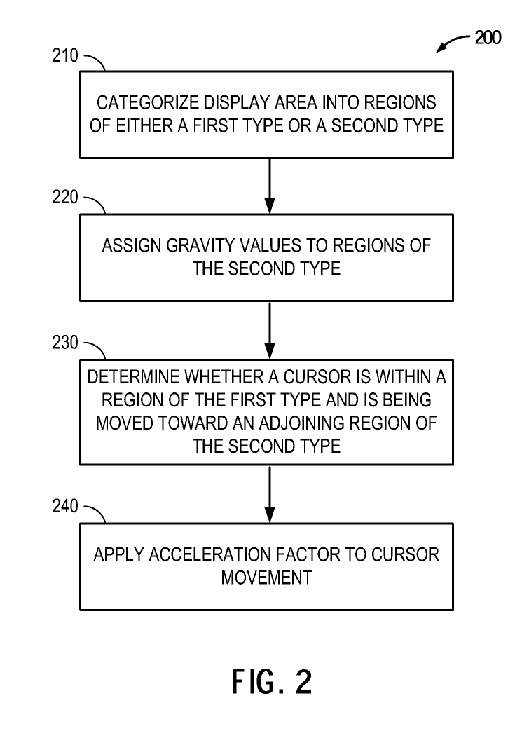

Referring to FIG. 2, a flowchart illustrating an exemplary method for run-time adaptive non-uniform mapping of UI events is shown. At block 210, the display area of a GUI may be categorized into regions of a first type or regions of a second type. Each region may include contiguous areas with no operable objects, a standalone operable object, or multiple closely located operable objects of a similar nature. For example, one region may contain a row of several closely located UI buttons; another region may contain a few paragraphs of selectable texts, etc. Contiguous areas with no operable objects may be included in one region. Regions with no operable objects may be categorized as being of a first type, and regions with at least one operable object may be categorized as being of a second type. At block 220, each region of the second type may be assigned an initial gravity value. As will be described below, regions with initial gravity values may later have their gravity values updated adaptively. In some embodiments, no gravity value is assigned to regions of the second type that do not adjoin any region of the first type for reasons that will become apparent from the description below. Different methods may be utilized to assign the initial gravity values. In one embodiment, all the regions of the second type may be assigned the same initial gravity value. In another embodiment, different initial gravity values may be assigned to regions of the second type based on relative importance. As an example used hereinafter, a larger gravity value may be associated with higher relative importance as well as a larger acceleration factor applied to cursor movement. Heuristics may be employed to make an a priori estimate of relative importance for each of the regions of the second type. For example, a region may be more important if it is more likely that a user would move the cursor toward the region. The heuristics may take into account factors such as the input device/method, the display device, the application(s), the UI layout, the sizes of UI elements, and the distance between UI elements, etc. In embodiments where different initial gravity values are assigned, more important regions may be assigned larger initial gravity values, and less important regions may be assigned smaller initial gravity values.

After initialization operations at blocks 210 and 220 are completed, at block 230, it is determined whether the cursor is located within a region of the first type and is being moved toward an adjoining region of the second type. Because a region of the first type has no operable objects in it, it is likely that the user is trying to move the cursor out of the first-type region when the cursor is being moved toward an adjoining region of the second type. At block 240, in response to determining that the cursor is located within a region of the first type and is being moved toward an adjoining region of the second type, an acceleration factor based at least in part on the gravity value of the adjoining region of the second type may be applied to the cursor movement to accelerate the cursor toward the region of the second type. The acceleration factor may be superposed on the cursor movement and may accelerate the cursor along its direction of movement. The exact mathematical relationship between the baseline cursor speed under linear mapping, the acceleration factor, and the accelerated cursor speed does not limit the disclosure. Generally speaking, a larger acceleration factor leads to a larger accelerating effect on the cursor movement. In one embodiment, the larger the gravity value associated with the adjoining region of the second type toward which the cursor is being moved, the larger the acceleration factor. In further embodiments, in addition to the gravity value associated with the adjoining region of the second type toward which the cursor is being moved, the acceleration factor may be further based on other factors, such as time, or the distance between the cursor and the adjoining region of the second type toward which the cursor is being moved. For example, the acceleration factor may increase as time passes when the cursor is being moved toward an adjoining region of the second type, or may increase as the distance between the cursor and the adjoining region of the second type toward which the cursor is being moved shortens. Of course, other forms of acceleration factors have been contemplated and the disclosure is not limited by the specific type of acceleration factor utilized.

Blocks 230 and 240 may be repeated to detect the cursor location and movement in real time and to apply, update, or cancel the acceleration factor accordingly. For example, if a cursor located in a region of the first type was previously being moved by the user toward an adjoining region of the second type and the user has stopped the movement, any acceleration factor previously applied is canceled as well, and the cursor movement is stopped. In another example, if a cursor located in a region of the first type was previously being moved by the user toward an adjoining region of the second type and the user has changed the direction of movement so that the cursor is no longer being moved toward an adjoining region of the second type, any acceleration factor previously applied is canceled, and the cursor resumes movement patterns under linear mapping or other default mapping schemes. The examples provided herein are illustrative and those of skill in the art should appreciate how the embodiments of the disclosure may work under many different scenarios of cursor movement. For example, it should be appreciated that the acceleration factor may be canceled once the cursor reaches the region of the second type, and that no acceleration factor may be applied when the cursor is located within a region of the second type.

In one embodiment, the gravity values for regions of the second type may be updated during run-time based on usage patterns. For example, after usage patterns have been collected and analyzed, gravity values for heavily-used regions may be increased, and gravity values for sparsely-used regions may be decreased. Thus, updating the gravity values based on usage patterns may improve user experience.

In another embodiment, the user may be provided with an option to invert gravity values or temporarily disable the gravity value-based cursor acceleration. In embodiments where gesture-based natural GUIs are utilized, one or more special gestures for invoking these options may be designated. For example, one special gesture may be a wave of a hand. The option of gravity value inversion is useful when the user wants to move the cursor easily to a region of the second type with a relatively small gravity value. A region may have a relatively small gravity value because, for example, the heuristics assigned a relatively small initial gravity to the region, or the region has been sparsely used compared to other regions and its gravity value has been decreased based on usage patterns, as described above. When the option to invert gravity values is invoked, gravity values for regions of the second type may be reassigned in a reverse order. For example, assuming a display area contains three regions i, ii, and iii of the second type and the three regions i, ii, and iii have gravity values a, b, and c, respectively, where a>b>c, when the option to invert gravity values is invoked, regions i, ii, and iii may be reassigned gravity values c, b, and a, respectively. Therefore, in this example, region iii, which had the smallest gravity value before the inversion, now has the largest gravity value.

When the option to temporarily disable the gravity value-based cursor acceleration is invoked, the cursor resumes movement patterns under uniform mapping or other default mapping schemes. Multiple methods for implementing this option may be utilized. For example, in one embodiment, when the option to temporarily disable the gravity value-based cursor acceleration is invoked, all regions are re-categorized as being of the first type. The disclosure is not limited by the specific implementation and any method for implementing the options may be utilized.

In yet another embodiment, the gravity value-based cursor acceleration may be automatically disabled when the currently active application in the display area falls into certain categories because certain types of applications do not lend themselves to non-uniform mapping for cursor movement. Examples of such applications may include games, list navigation applications, etc.

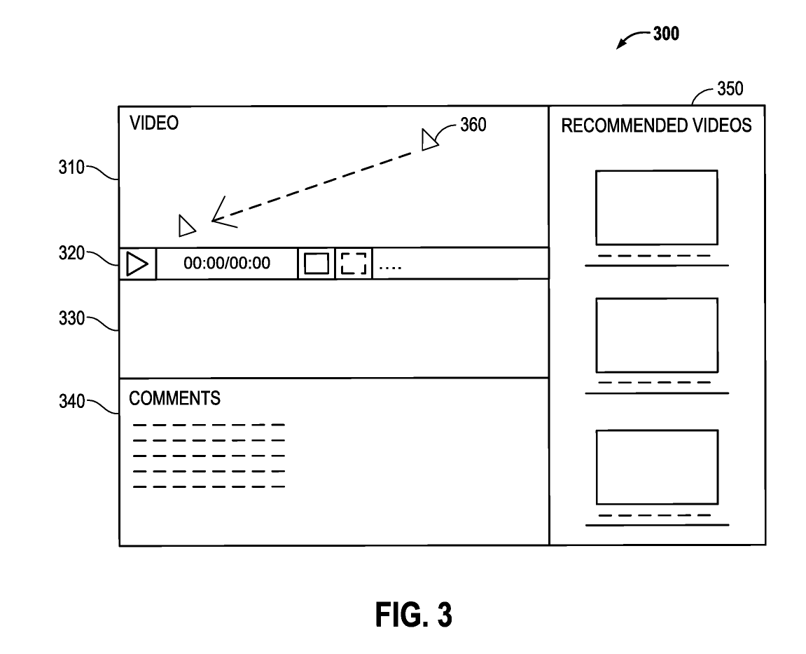

Referring to FIG. 3, an exemplary display area 300 where methods for run-time adaptive non-uniform mapping of UI events may be utilized is shown. Display area 300 is partitioned into several regions at block 210 of FIG. 2. For example, Region 310 contains a video playback area where no user operation is possible and therefore is categorized into the first type. Region 320 contains UI buttons for video playback controlling and therefore is categorized into the second type. Region 330 is a blank region where no operable object is present and therefore is categorized into the first type. Region 340 contains comments on the video, i.e., selectable texts, and therefore is categorized into the second type. And region 350 contains links to recommended videos, i.e., clickable links, and therefore is categorized into the second type. Initial gravity values are assigned to regions 320, 340, and 350 at block 220 of FIG. 2. Methods for assigning initial gravity values as described above may be utilized. When cursor 360 is within region 310 and is being moved toward either region 320 or 350, or when cursor 360 is within region 330 and is being moved toward any one of regions 320, 340, or 350, it is determined at block 230 of FIG. 2 that cursor 360 is located within a region of the first type and is being moved toward an adjoining region of the second type. For all other scenarios, it is determined at block 230 of FIG. 2 that either cursor 360 is not located within a region of the first type or cursor 360 is not being moved toward an adjoining region of the second type. In response to a determination that cursor 360 is located within a region of the first type and is being moved toward an adjoining region of the second type, an acceleration factor may be applied at Block 240 of FIG. 2 to cursor 360 to accelerate cursor 360 in the direction of movement. Methods for applying an acceleration factor described above may be utilized.

In one embodiment, the user may frequently move cursor 360 from either region 310 or region 330 into region 320 to click on the play/pause button. Accordingly, the gravity value of region 320 may be increased to reflect an increase in region 320's recognized importance based on usage patterns. As described herein, a higher gravity value for region 320 may lead to a larger acceleration factor being applied when cursor 360 is moved toward region 320 from region 310 or region 330. Therefore, it becomes easier for the user to move cursor 360 into region 320 as the user repeats the same operation.

By utilizing embodiments of the disclosure described herein, a user may operate a GUI (e.g., a natural GUI) with greater ease. It should be appreciated that embodiments of the disclosure described herein do not require any modifications to be made to the applications.

It should be appreciated that aspects of the disclosure previously described may be implemented in conjunction with the execution of instructions (e.g., applications) by processor 110 of computing device 100, as previously described. Particularly, circuitry of the device 100, including but not limited to processor 110, may operate under the control of an application, program, routine, or the execution of instructions to execute methods or processes in accordance with embodiments of the disclosure (e.g., the processes of FIG. 2). For example, such a program may be implemented in firmware or software (e.g., stored in memory and/or other locations) and may be implemented by processors and/or other circuitry of the devices. Further, it should be appreciated that the terms processor, microprocessor, circuitry, controller, etc., refer to any type of logic or circuitry capable of executing logic, commands, instructions, software, firmware, functionality, etc.

The teachings herein may be incorporated into (e.g., implemented within or performed by) a variety of apparatuses (e.g., devices). For example, one or more aspects taught herein may be incorporated into a general computing device, a desktop computer, a mobile computer, a mobile device, a phone (e.g., a cellular phone), a personal data assistant, a tablet, a laptop computer, a tablet, an entertainment device (e.g., a music or video device), a headset (e.g., headphones, an earpiece, etc.), a medical device (e.g., a biometric sensor, a heart rate monitor, a pedometer, an EKG device, etc.), a user I/O device, a computer, a server, a point-of-sale device, an entertainment device, a set-top box, or any other suitable device.

In some aspects a wireless device may comprise an access device (e.g., a Wi-Fi access point) for a communication system. Such an access device may provide, for example, connectivity to another network through transceiver (e.g., a wide area network such as the Internet or a cellular network) via a wired or wireless communication link. Accordingly, the access device may enable another device (e.g., a Wi-Fi station) to access the other network or some other functionality. In addition, it should be appreciated that one or both of the devices may be portable or, in some cases, relatively non-portable.

It should be appreciated that when the devices are mobile or wireless devices that they may communicate via one or more wireless communication links through a wireless network that are based on or otherwise support any suitable wireless communication technology. For example, in some aspects the wireless device and other devices may associate with a network including a wireless network. In some aspects the network may comprise a body area network or a personal area network (e.g., an ultra-wideband network). In some aspects the network may comprise a local area network or a wide area network. A wireless device may support or otherwise use one or more of a variety of wireless communication technologies, protocols, or standards such as, for example, 3G, LTE, LTE Advanced, 4G, CDMA, TDMA, OFDM, OFDMA, WiMAX, and WiFi. Similarly, a wireless device may support or otherwise use one or more of a variety of corresponding modulation or multiplexing schemes. A wireless device may thus include appropriate components (e.g., air interfaces) to establish and communicate via one or more wireless communication links using the above or other wireless communication technologies. For example, a device may comprise a wireless transceiver with associated transmitter and receiver components (e.g., a transmitter and a receiver) that may include various components (e.g., signal generators and signal processors) that facilitate communication over a wireless medium. As is well known, a mobile wireless device may therefore wirelessly communicate with other mobile devices, cell phones, other wired and wireless computers, Internet web-sites, etc.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art would further appreciate that the various illustrative logical blocks, modules, engines, circuits, and algorithm steps described in connection with the embodiments disclosed herein may be implemented as electronic hardware, computer software, or combinations of both. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions or modules may be stored on or transmitted over as one or more instructions or code on a non-transitory computer-readable medium. Computer-readable media can include both computer storage media and communication media including any medium that facilitates transfer of a computer program from one place to another. A storage media may be any available media that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method for run-time adaptive non-uniform mapping of user interface events comprising:
categorizing a display area into a plurality of regions of either a first type or a second type, regions of the first type having no operable user interface object, and regions of the second type having at least one operable user interface object each;
assigning a gravity value to each of the regions of the second type;
determining whether a cursor is within a first region of the first type and is being moved toward a second region of the second type that adjoins the first region; and
in response to determining that the cursor is within the first region of the first type and is being moved toward the second region of the second type, the second region having a first gravity value, applying an acceleration factor based at least in part on the first gravity value to a cursor movement.

2. The method of claim 1, further comprising updating the gravity values based at least in part on usage patterns.

3. The method of claim 1, further comprising inverting the gravity values in response to a user input.

4. The method of claim 3, wherein the user input is a wave of a hand.

5. The method of claim 1, further comprising removing the acceleration factor in response to a user input or to a determination that a currently active application in the display area is of a particular type.

6. The method of claim 1, wherein the one or more gravity values are assigned based on heuristics, and wherein the heuristics are based on at least one of an input device, an input method, a display device, an application, a function of a user interface (UI) element, a size of a UI element, or a distance between UI elements.

7. An apparatus adapted for a method for run-time adaptive non-uniform mapping of user interface events comprising:
a memory; and
a processor to:
categorize a display area into a plurality of regions of either a first type or a second type, regions of the first type having no operable user interface object, and regions of the second type having at least one operable user interface object each,
assign a gravity value to each of the regions of the second type,
determine whether a cursor is within a first region of the first type and is being moved toward a second region of the second type that adjoins the first region, and
in response to determining that the cursor is within the first region of the first type and is being moved toward the second region of the second type, the second region having a first gravity value, apply an acceleration factor based at least in part on the first gravity value to a cursor movement.

8. The apparatus of claim 7, wherein the processor is further to update the gravity values based at least in part on usage patterns.

9. The apparatus of claim 7, wherein the processor is further to invert the gravity values in response to a user input.

10. The apparatus of claim 9, wherein the user input is a wave of a hand.

11. The apparatus of claim 7, wherein the processor is further to remove the acceleration factor in response to a user input or to a determination that a currently active application in the display area is of a particular type.

12. The apparatus of claim 7, wherein the one or more gravity values are assigned based on heuristics, and wherein the heuristics are based on at least one of an input device, an input method, a display device, an application, a function of a user interface (UI) element, a size of a UI element, or a distance between UI elements.

13. An apparatus adapted for a method for run-time adaptive non-uniform mapping of user interface events comprising:
means for categorizing a display area into a plurality of regions of either a first type or a second type, regions of the first type having no operable user interface object, and regions of the second type having at least one operable user interface object each;
means for assigning a gravity value to each of the regions of the second type;
means for determining whether a cursor is within a first region of the first type and is being moved toward a second region of the second type that adjoins the first region; and
means for in response to determining that the cursor is within the first region of the first type and is being moved toward the second region of the second type, the second region having a first gravity value, applying an acceleration factor based at least in part on the first gravity value to a cursor movement.

14. The apparatus of claim 13, further comprising means for updating the gravity values based at least in part on usage patterns.

15. The apparatus of claim 13, further comprising means for inverting the gravity values in response to a user input.

16. The apparatus of claim 15, wherein the user input is a wave of a hand.

17. The apparatus of claim 13, further comprising means for removing the acceleration factor in response to a user input or to a determination that a currently active application in the display area is of a particular type.

18. The apparatus of claim 13, wherein the one or more gravity values are assigned based on heuristics, and wherein the heuristics are based on at least one of an input device, an input method, a display device, an application, a function of a user interface (UI) element, a size of a UI element, or a distance between UI elements.

19. A non-transitory computer-readable medium including code that, when executed by a processor, causes the processor to:
categorize a display area into a plurality of regions of either a first type or a second type, regions of the first type having no operable user interface object, and regions of the second type having at least one operable user interface object each,
assign a gravity value to each of the one or more regions of the second type,
determine whether a cursor is within a first region of the first type and is being moved toward a second region of the second type that adjoins the first region, and
in response to determining that the cursor is within the first region of the first type and is being moved toward the second region of the second type, the second region having a first gravity value, apply an acceleration factor based at least in part on the first gravity value to a cursor movement.

20. The non-transitory computer-readable medium of claim 19, further comprising code for updating the gravity values based at least in part on usage patterns.

21. The non-transitory computer-readable medium of claim 19, further comprising code for inverting the gravity values in response to a user input.

22. The non-transitory computer-readable medium of claim 21, wherein the user input is a wave of a hand.

23. The non-transitory computer-readable medium of claim 19, further comprising code for removing the acceleration factor in response to a user input or to a determination that a currently active application in the display area is of a particular type.

24. The non-transitory computer-readable medium of claim 19, wherein the one or more gravity values are assigned based on heuristics, and wherein the heuristics are based on at least one of an input device, an input method, a display device, an application, a function of a user interface (UI) element, a size of a UI element, or a distance between UI elements.
